(19) United States
(12) Patent Application Publication
(10) Pub. No.: US 2025/0388006 A1
(43) Pub. Date: Dec. 25, 2025

(54) PAPER-BASED PACKAGING FILM AND PACKAGE COMPRISING THE FILM

(71) Applicant: AMCOR FLEXIBLES NORTH AMERICA, INC., Neenah, WI (US)

(72) Inventors: Francois DUCHENE, Schiltigheim (FR); Remi DE BIGOUSE, Lyon (FR); Pieter COOLS, Aalter (BE); Giorgio DINI, Cislago (IT); Nils DE RYBEL, Destelbergen (BE)

(21) Appl. No.: 18/880,389

(22) PCT Filed: Jun. 28, 2023
(86) PCT No.: PCT/US2023/026478

§ 371 Date: Dec. 31, 2024

Related U.S. Application Data
(60) Provisional application No. 63/369,267, filed on Jul. 25, 2022.

(51) Int. Cl. B32B 27/10; B32B 7/06; B32B 7/12; B32B 27/32

(52) U.S. Cl. CPC B32B 27/10; B32B 7/06; B32B 7/12; B32B 27/32; B32B 2250/02; B32B 2255/10; B32B 2255/12; B32B 2255/205; B32B 2255/26; B32B 2255/28; B32B 2307/31; B32B 2307/4023; B32B 2307/518; B32B 2307/718; B32B 2307/7244; B32B 2307/7246; B32B 2307/7265; B32B 2307/7376; B32B 2439/70

(57) ABSTRACT

The present invention relates to a paper-based packaging film having a first major outer surface and a second major outer surface, the paper-based packaging film comprising: a paper component; a polymeric film; and a patterned sealable material; wherein the first major outer surface comprises one or more first surface regions provided by the patterned sealable material and one or more second surface regions provided by the paper component. The present invention also relates to packages formed from or including a paper-based packaging film and optionally a product, such as a product having a cuboid shape.

### TECHNICAL FIELD

The present disclosure is directed to paper-based packaging film structures. In particular, the present disclosure is directed to paper-based packaging films for packaging articles like food, as well as other articles.

### BACKGROUND

The goal of increasing recyclability of paper-based multilayer packaging films becomes challenging when attempting to form films that are intended to protect a packaged product, such as a food product, from its external environment. Traditionally, a packaged product is protected by forming a multilayer film having a plurality of specific layers. As performance demands increase, the multitude of layers or thickness of the layers in the multilayer film increase, working against the recyclability of the structure as the mass percentage of the paper content decreases.

Many products are packaged on high-speed packaging equipment, putting further demands on the packaging materials for runnability.

Additionally, since the package is often a main source of product marketing, the appearance of the package is also critical.

Often, when high performance is desired from paper-based multilayer packaging films, relatively high amounts of additional non-paper materials are added to the paper-based packaging films. For example, for packaging certain products, such as food products, for example bouillon cubes, the packaging materials are required to provide barrier properties against grease, aroma and moisture (water and water vapour) and oxygen, most typically against grease and moisture.

Products containing grease, for example, bouillon cubes, can leave grease stains on a paper material used for packaging. One solution in the art is to use grease resistant paper materials for packaging. Grease resistance has been provided in the past by adding organophopic components to the paper either as a mass treatment or as a coating. Organophopic components used in the art for this purpose include poly- or perfluoro alkyl substances (PFAS), wax (paraffin) and polyvinylidene chloride (PVDC) and silicones. Such components may not be compliant with food safety rules and/or may interfere with the repulping in a paper recycling process. Hence, these conventional solutions are not repulpable and recyclable solutions. Components like wax can themselves leave markings when heated (for example for sealing). In addition, wax can cause stickies or accumulate on machine parts in a paper recycling process.

There exists a need for paper-based flexible packaging films having high barrier properties (in particular, against moisture and grease), folding properties, and excellent sealing performance, while maintaining recyclability in paper recycling process, such as in a standard paper recycling process.

There is also a need for paper-based packaging films which can be used for packaging grease-containing products, while maintaining recyclability in a paper recycling process, such as a standard paper recycling process. Preferably, the packaging films should also be able to maintain excellent appearance during packaging converting and package use and storage (for example, not be susceptible to stains from grease). In addition, the packaging films can be used on high-speed packaging machines, i.e., they have good runnability.

### SUMMARY

Disclosed herein are paper-based packaging films meeting the above demands. The paper-based packaging films disclosed herein have high barrier properties (in particular, against moisture and grease), good folding properties, and excellent sealing performance. The films also have excellent appearance and runnability while maintaining recyclability in a paper recycling process, such as a standard paper recycling process.

The packaging films comprise a paper component and include minimal amounts of non-fiber-based materials (i.e., minimal amounts of non-paper materials) to achieve high barrier properties and excellent sealing performance while maintaining paper recyclability. The paper-based flexible packaging films are useful for packaging products, including but not limited to cuboid food products, e.g., bouillon cubes.

The paper-based packaging films include a polymeric film, a paper component, and a patterned sealable material. The paper-based packaging films may include additional materials, such as adhesive and/or barrier material. The barrier material may be located between the paper component and the polymeric film. The adhesive may attach the polymeric film or the barrier material, if present, to the paper component. The total composition of the paper-based packaging film may be greater than or equal to 80%, greater than or equal to 85%, greater than or equal to 90% or greater than or equal to 95%, by weight, of the paper component.

In some embodiments of the paper-based packaging film, the polymeric film may include an oriented or unoriented film and may optionally further include a coating of a barrier material, typically on one side thereof. An example of barrier coating is a metal or oxide barrier coating. A polymeric film including a barrier material coated thereon, for example any metal or oxide barrier coating, is also referred to herein as a “polymeric barrier film”. In some embodiments, the polymeric film may be attached to the paper component by an adhesive.

Some embodiments of the paper-based packaging film can be described as having an exterior surface and an interior surface, a polymeric film, the polymeric film being any oriented or unoriented film, optionally but preferably including any metal or oxide barrier coating, a paper component, and a patterned sealable material. Typically, the barrier coated side of the polymeric film is facing towards the paper component. For example, in embodiments, the barrier coated side of the polymeric film is attached to the paper component by an adhesive, such as a water-sensitive adhesive. In one or more embodiments, the interior surface comprises a polymeric film, and the exterior surface comprises each of the paper component and the patterned sealable material.

The paper-based packaging film may have a total composition of greater than or equal to 80%, greater than or equal to 85%, greater than or equal to 90% or greater than or equal to 95%, by weight, of paper (i.e., the paper component).

The paper-based packaging film may incorporate a sealable material that is heat sealable, e.g., a heat seal lacquer. The paper-based packaging film may comprise an adhesive which may be a water-based adhesive. The paper-component may be selected from grease proof papers.

In typical embodiments, the paper-based packaging films have a first major outer surface and a second major outer surface, wherein the first major outer surface comprises one or more first surface regions provided by the patterned sealable material and one or more second surface regions. The second major outer surface may be provided by the polymeric film.

The present invention also relates to packages formed from or including a paper-based packaging films as described herein. The packages can be sealed by the patterned sealable material. In the packages the patterned sealable material is typically facing away from the product and typically facing towards the environment.

Some embodiments of the package can be described as a packaged cuboid products comprising the paper-based packaging film as described herein, and a product having a cuboid shape; wherein the paper-based packaging film is wrapped around the product such that the first major surface of the packaging film is facing away from the product.

### BRIEF DESCRIPTION OF THE DRAWINGS

The disclosure may be more completely understood in consideration of the following detailed description of various embodiments of the disclosure in connection with the accompanying drawings, in which:

FIG. 1 is a perspective view of an exemplary packaged cuboidal product;

FIG. 2 is a cross-sectional view of an exemplary paper-based packaging film;

FIG. 3a is a cross-sectional view of an exemplary paper-based packaging film;

FIG. 3b is a cross-sectional view of an exemplary paper-based packaging film;

FIG. 4 is a cross-sectional view of an exemplary paper-based packaging film; and

FIG. 5 is a plan view of the first major surface (exterior surface) of an embodiment of a paper-based packaging film.

FIG. 6 is a plan view of a first major surface (exterior surface) of an embodiment of a paper-based packaging film.

FIG. 7 is a plan view of a first major surface (exterior surface) of an embodiment of a paper-based packaging film.

The drawings show some but not all embodiments. The elements depicted in the drawings are illustrative and not necessarily to scale, and the same (or similar) reference numbers denote the same (or similar) features throughout the drawings.

### Definitions

Unless otherwise specified, the following terms as used herein have the meanings provided below.

The terms “preferred” and “preferably” refer to embodiments of the invention that may afford certain benefits under certain circumstances. However, other embodiments may also be preferred, under the same or other circumstances. Furthermore, the recitation of one or more preferred embodiments does not imply that other embodiments are not useful, and it is not intended to exclude other embodiments from the scope of the present disclosure.

The term “layer”, as used herein, refers to a building block of films. A layer is a structure of a single material type or a homogeneous blend of materials. A layer may be a single polymer, a blend of materials within a single polymer type or a blend of various polymers. A layer may contain metallic materials or paper and may have additives. Paper is typically present in the form of a paper layer. As used herein, the term “paper” or “paper layer” refers to the paper material (cellulose plus optionally including conventional paper additives, such as fillers, sizing agents clay) in the form of a layer, not including components such as ink and/or overlacquer. Layers of materials described herein may be continuous with the paper-based packaging film or may be discontinuous or patterned. Both layers and films have a relatively insignificant thickness (z-direction) as compared to their respective length and width (x-y direction).

All layers and films described herein have two major surfaces, opposite each other, defined by the x-y plane. The term “outer layer” as used herein refers to one or more layers of a film that are on either major surface of the film, i.e., the layers that are not between two other layers of that film. A film has an exterior surface that becomes the exterior of a package in which the film is used. When formed into a package, the exterior surface of the film is exposed to the environment. A film has an interior surface that becomes the interior of a package in which the film is used. When formed into a package, the interior surface is used for forming seals and is exposed to the packaged product.

As used herein, the term “adjacent” means that the items, such as layers of a film, are near each other, with or without intervening material, such as adhesive. As used herein, the term “directly adjacent” or “in direct contact with” means that the items are in contact with each other, without intervening material.

The term “connected” when used with respect to two adjacent structural elements of the packaging film (i.e., paper components, materials, films or layers as described herein) means that such structural elements are provided separately and subsequently connected to each other by any suitable means, with or without intervening material, such as adhesive. Hence, the term “connected” as used herein is intended to distinguish from (and preferably intended to exclude) coextrusion or coating methods to provide the two adjacent structural elements. For example, the term “polymeric film connected to the paper component” means that the polymeric layer constituting the polymeric film and the paper component are provided separately and subsequently connected to each other by any suitable means, with or without intervening materials. Hence, the polymeric material providing the polymeric film of the paper-based packaging film described herein is preferably not applied onto the paper component by use of methods involving coating of the polymeric material onto the paper component.

The term “paper” or “paper layer” refers to the material based on cellulose including any additives typically used in papers common in the paper industry such as: fillers, sizing agents and clay coatings.

The “paper content” of the paper-based packaging film can be determined by dividing the mass of the paper used (the paper or paper layer, including any conventional paper additives) divided by the total mass of the paper-based packaging film (including: paper layer, polymer film and patterned sealable material, and including optionally any one or more of barrier material, adhesive, ink, overlacquer and any other material(s) which might be present but which are not “paper layer”).

It should be noted that the paper content is in some instances not the same as the “recoverable content” as sometimes not all of a paper-based product can be fully recycled as combining paper with non-paper materials can lead to a non-recyclable product. The term “recoverable content” or “recoverable pulp content” of a paper-based packaging film is defined herein as the mass fraction of material that can be recovered to create new paper (typically pulp and anything else captured with the pulp). The recoverable content can be determined by a test that mimics the repulping process, such as the one described herein. Preferably, the recoverable content is maximized to maximize the incentive for recyclers to collect the packaging product, therefore values of 80% or more are considered a rule of thumb when designing paper-based packaging products but in some countries values down to 50% are considered acceptable.

The term “paper component” refers to paper or paper layer plus optionally comprising other components added after the paper's original manufacture, for example ink and/or overlacquer.

The term “recyclability” of paper-based packaging generally relates to the individual suitability of a paper-based packaging for its factual reprocessing in the post-use phase into new paper and board; factual means that separate collection (where relevant and followed by sorting) into grades according to EN 643 “European list of standard grades of paper and board for recycling” and final recycling takes place on an industrial scale. Standard paper recycling mills typically have equipment and processes to produce high quality end-products based on EN643 groups 1 to 4 with a classic low consistency pulper (5% fibre concentration). Often such processes operate deflakers to separate fibre bundles into individual fibres, as well as coarse and fine screening cleaners. The aim is to separate the fibre from the other material. The final result is fibrous material suspended in water ready for papermaking (=recycled pulp). Specialized recycling mills can treat a mix of special grades (group 5 of EN 643) and grades from other groups (1-4 from EN 643). The recovered paper stock preparation process for the packaging stream (Cat. 2) typically does not include a deinking step for the removal of printing inks. As opposed to a standard recycling mill, a specialized recycling mill determines the optimal mix and adds one or more piece of dedicated equipment, such as a horizontal high density drum pulper, a separate batch pulper with longer pulping time, deinking, fine cleaners, hot dispersion, special process and waste water systems. As in standard mills, the final result of the process is also fibrous material suspended in water ready for papermaking.

As used herein, the terms “standard paper recycling process” or are intended to refer to a waste-paper recycling process that may include one and typically more or all common steps selected from repulping, screening, flotation, roughing, concentration, defibrinating, deinking, washing, purification, and bleaching, as is known in the art.

The paper-based packaging films described herein as well as packages prepared therefrom are suitable for recycling in a standard recycling paper process (i.e., they can be processed in a standard paper mill). For the purposes of the present invention recyclability (i.e., the suitability of a paper-based packaging film or package obtained therefrom to be processed in a standard paper recycling process) can be established using standard laboratory testing simulating the industrial standard waste paper process on a laboratory scale, based on characteristics including repulpability and sheet formation. The testing procedure comprises a disintegrating step (pulping step) which is typically performed using a standard disintegrator (according to ISO 5263-1). Testing procedures may comprise one or more of the following phases: disintegration, filtrate analysis; determination of the coarse reject (for example 5 mm hole residue), determination of the consistency after the coarse screening (AC); sheet adhesion test and visual appearance test of the accept of the coarse screening; determination of the fine reject (for example, 150 μm slot residue); sheet adhesion test and visual appearance test of the accept of the fine screening, determination of the content of adhesive particles (macro stickies); The testing procedure may optionally include a sheet forming step (total stock), which may include sheet adhesion testing and a visual appearance test, both typically optional. Specific testing may include one or more the following: measurement of coarse rejects, measuring the flake content (fine reject, according to TAPPI T275 sp18), calculation of the content of soluble and colloidal solids below 10 microns (measured according to ISO 4119), measurement of the area of adhesive particle (macro stickies, according to ISO 15360-2, optionally), indication of the ash content (measured according to ISO 1762, optionally). Standard testing protocols suitable to establish recyclability of a paper-based packaging film or package made therefrom in a standard paper recycling process include one or more of PTS-RH 021-Cat. 2, Aticelca 501 (2019) and the CEPI “Harmonized European laboratory test method to produce parameters enabling the assessment of the recyclability of paper and board products in standard paper and board recycling mills—Version 2”. For the purpose of the present invention, recyclability of the paper-based packaging film or a product made therefrom means that the film or product achieves at least good ratings in accordance with at least one, two or all of these standards, such as at least level B when rated according to Aticelca 501 (2019).

The criteria used in the assessment of the recyclability PTS-RH 021-Cat. 2 are repulpability (mass percentage of the constituents not usable in papermaking) and undisturbed sheet formation (purity of the furnish mass percentage usable in papermaking regarding stickies or optical inhomogeneities).

The Aticelca 501 (2019) system is an evaluation based on a laboratory analysis, developed by Aticelca starting from 2011 and which became the UNI 11743:2019. The analysis simulates the main phases of the industrial process of manufacturing paper to be recycled up in a standard recycling process to producing a new sheet of paper. The technical standard Aticelca 501 (2019) reproduces at laboratory scale what happens at industrial scale when a paper mill recycles the paper for recycling. Pulping, fibre cleaning and sheet formation are performed. The following parameters are measured: coarse rejects, flake content, macrostickies area, sheet formation and adhesiveness, optical inhomogeneities, and ash content (optional). The result of the laboratory tests, which analyze the main elements that characterize the recyclability of paper and cardboard and of the products obtained with them, is summarized by an index scaled in four levels of recyclability: A+, A, B, C (and not recyclable), A+ being the highest recyclability level.

The CEPI Recyclability Test Method—Version 2 describes a laboratory scale method for determining the key parameters for evaluating the level of recyclability of paper and board-based materials and other cellulose fibre-based products, emulating the relevant phases of standard paper and board recycling mills without deinking technology or other special features to recycle paper for producing new paper and board. This method enables analyzing both process parameters (coarse reject, fine reject, dissolved and colloidal substances and stickie particles with a diameter smaller than 2 mm) and quality parameters (sheet formation and interfering materials like adhesiveness and visual impurities) of products produced from recycled fibres. This document considers only the minimum characteristics of paper and board products that can be generally recycled. Therefore, it does not take into consideration additional specifications necessary to valorize the paper and board products using deinking technologies. It also does not include parameters of recyclability in mills with specialized processing technology.

As used herein the term “fat” is intended to include fats as relating to the molecular form of a family of nutrients based on fatty acids. Fats can be solid or liquid (at room temperature), depending on the fatty acid(s) contained. Liquid fats are referred to as “oils”. The term “fat” as used herein is intended to include solid fats and liquid fats, i.e., oils.

As used herein the term “grease” is intended to include substances that have similar physical properties (for example, in terms of melting point and density) but are not considered pure fats, for example because they do not fall into the class of fats as defined herein (i.e., they are not fatty acid triglycerides) or have additional components. “Grease” as used herein is intended to also encompass fats as defined herein (including semi-solid and solid fats and oils) as well as substances derivable from fat (for example, by chemical reaction (for example, cleavage of ester groups, salt formation) or physical treatments (for example, heating)), including fatty acids and salts thereof.

The term “barrier material” is well known in the art of packaging. A barrier material is commonly understood as a single material or combination of materials designed to reduce diffusion of substances such as water, gas (such as oxygen), fat (in particular oils) or aroma through a packaging material. A barrier material helps to prevent deterioration of the package and/or the packaged product, as is well known in the art.

As described herein, the “total composition” of the paper-based packaging film refers to all materials encompassed therein. The total composition of the paper-based packaging film includes the paper content (i.e., cellulose fiber content) and the non-paper content (i.e., all other materials, for example polymeric film, patterned sealable material, optional components like adhesive, barrier material, ink and overlacquer, and any other optional components that might be encompassed).

As used herein, the term “basis weight” is used to refer to the amount of material by weight is present in a predetermined area of a component, film or layer. Typically, the area defined is a square meter, but any area can be used. The area is defined in the length-width (i.e., x-y direction) of the film or layer. A material of a given thickness (z-direction) and density, has a specific weight when covering a defined area (i.e., a square meter). Basis weight is a commonly used measurement of weight for paper because the density of paper can vary widely. Stated differently, measuring paper by thickness can be difficult. Materials that are applied in discontinuous layers, such as the patterned sealable material, can be defined by basis weight. In the case of patterns, the basis weight refers to the amount of material by weight that is present when covering a defined area. The use of basis weight to measure weight of materials such as paper and patterned materials is common in the film converting industry.

As used herein, the term “water sensitive” means that upon prolonged exposure to or immersion in liquid water, the adhesive layer loses its adhesive and/or cohesive properties, thus enabling the delamination (i.e., separation) of the paper component from the rest of the paper-based packaging film structure during a repulping process. Water-sensitivity can be established using a standard laboratory pulp disintegrator using water, 40°+/−5° C. water and 30,000 rotations. Preferably, a suitable adhesive does not interfere with recycling in a standard paper recycling process, as determined according to the recyclability standards described herein. For example, when testing according to the Aticelca and PTS protocol a suitable adhesive will allow the fibers release from the packaging film, producing an acceptable recoverable content, such as for example at least or greater than 80% or at least or greater than 85% or at least or greater than 90% of the paper-based packaging film. An adhesive could be suitably selected so to preferably result in grading of at least level B, at level A or even level A+ according to Aticelca 501 (2019).

### DETAILED DESCRIPTION

### Packaging Film

Provided herein are paper-based packaging films that overcome the short comings of previously provided films. The paper-based packaging films of the present disclosure are uniquely designed to deliver a critical combination of recyclability, ease of package converting, such as by folding (for example when packaging cuboid shaped products), high barrier (in particular against moisture and grease), excellent sealability, excellent runnability (i.e., high run speed) on packaging equipment and excellent appearance.

The paper-based packaging films described herein include a paper component, a polymeric film and a patterned sealable material. In certain embodiments, the paper-based packaging films include a paper component, a polymeric film, a barrier material and a patterned sealable material. The paper-based packaging films may include additional layers. The combination of these materials can be described as a multilayer film (e.g., a structure or a laminate).

The paper-based packaging film has a first major outer surface and a second major outer surface. The first major outer surface may comprise one or more first surface regions provided by the patterned sealable material and one or more second surface regions provided by the paper component. The second major outer surface can be provided by the polymeric film, although this is not a necessary requirement.

When used for packaging, the first major surface may become the exterior surface of the package in which the film is used (i.e., it is exposed to the environment) and the second major surface may become the interior surface of the package in which the film is used (i.e. it faces towards the product being packaged).

The total composition of the paper-based packaging film may include greater than or equal to 80%, greater than or equal to 85%, greater than or equal to 90%, or greater than or equal to 95%, by weight, of the paper. The total composition of the paper-based packaging film may include less than or equal to 99%, less than or equal to 98%, less than or equal to 97%, or less than or equal to 96%, by weight, of the paper. For example, the paper-based packaging film may comprise in a range of about 85% to about 98% of the paper component (of cellulose fibers of the paper), by weight of the total composition. Worded differently, the paper content of the paper-based packaging film may be greater than or equal to 80%, greater than or equal to 85%, greater than or equal to 90%, or greater than or equal to 95%, by weight. The paper content of the paper-based packaging film may include less than or equal to 99%, less than or equal to 98%, less than or equal to 97%, or less than or equal to 96%, by weight, of the paper. For example, the paper content of the paper-based packaging film may range from about 85% to about 98%.

The paper-based packaging films may achieve a recoverable content (as determined by a suitable repulpability test, for example the test described herein) of greater than or equal to 80%, greater than or equal to 85%, greater than or equal to 90%, or greater than or equal to 95%, by weight, based on the total weight of the paper-based packaging film. The recoverable content of the paper-based packaging film may be less than or equal to 99%, less than or equal to 98%, less than or equal to 97%, or less than or equal to 96%, by weight, based on the total weight of the paper-based packaging film. For example, the paper-based packaging film may comprise in a range of about 85% to about 98%, based on the total weight of the paper-based packaging film.

The paper-based packaging films described herein comprise paper (i.e., a paper layer) and include minimal amounts of non-fiber-based materials (i.e., minimal amounts of non-paper materials). For example, the paper-based packaging film may include minimal amounts of non-paper materials, such as provided by the polymeric film, patterned sealable material, and any optional components described herein, such as adhesive, barrier material, ink and overlacquer, and any other components that might be encompassed and which are not paper. For example, the total composition of the paper-based packaging film may include equal to or less than 20%, or equal to or less than 15%, or equal to or less than 10%, or equal to or less than 5, or equal to or less than 4, or equal to or less than 3, or equal to or less than 2, or equal to or less than 1% by weight of non-paper components, based on the total composition of the packaging film. For example, the total composition of the paper-based packaging film may include equal to or greater than 0.5% or equal to or greater than 0.8%, or equal to or greater than 1% or equal to or greater than 1.5% by weight of non-paper components, based on the total composition of the packaging film.

The paper-based packaging films and products made therefrom are typically recyclable, for example when established following one, or two or all of the protocols mentioned herein. The paper-based packaging films may achieve grading B, A or even A+ according to the Aticelca standard. For example, a paper-based packaging film having a paper content of greater than 85% can achieve grading A according to the Aticelca standard.

### Paper Component

The paper-based packaging films disclosed herein include a paper component.

The paper component is located at an outer layer of the paper-based packaging film and is preferably located at an exterior surface of the paper-based packaging film (i.e., with respect to a package in which the film is used).

The paper component may comprise any type of paper. Suitable types of paper may have a basis weight of 30 g/m² to 360 g/m², preferably 30 g/m² to 100 g/m², more preferably 30 g/m² to 70 g/m², most preferably 50 g/m². Low paper component weight is possible, while retaining easy recyclability, because the additional components (i.e., the non cellulose fiber content) are minimized.

The paper component may comprise any type of paper. The paper used is preferably selected from paper types that can be processed in a standard paper recycling process. Suitably, the paper used may be repulpable, for example mechanically and/or chemically. A paper may be selected based on a repulpability test as described herein for the packaging film.

The paper component can consist of a paper layer (i.e., cellulose fibers and optionally including any conventional paper additives and/or surface treatments). The paper component can also comprise a paper layer and optionally one or more of additional elements, such as for example one or more of paper surface treatment(s), ink and over lacquer. Such additional elements, if present, may be located on the exterior surface of the paper layer and may be comprised by the second surface regions.

As used herein, the term “paper surface treatment” refers to one or more types of conventional paper treatments applied on one or both major surfaces of the paper layer. Surface treatments can include physical and/or chemical surface treatments, as is known in the art.

Physical treatments include calendaring and supercalendering. The paper component may comprise calendered or supercalendered paper, such as glassine.

Exemplary chemical surface treatments can comprise applying one or more of agents selected from inorganic surface treatment agents, organic surface treatment agents and combinations thereof. Exemplary inorganic agents can for example be selected from kaolinite, calcium carbonate, bentonite and talc and chalk or clay, as is well known in the art. Exemplary organic agents can for example be selected from starches, alginates, carboxymethyl celluloses, and polyvinyl alcohol and combinations thereof. In embodiments, the paper component comprises a paper layer having at least one surface treatment on one or both sides thereof with one or more agents independently selected from starches, alginates, carboxymethyl celluloses, polyvinyl alcohol, from kaolinite, calcium carbonate, bentonite and talc and chalk and combinations thereof.

The surface treatments can be applied on one or both sides of the paper. Surface treatments can result in coating(s) on one or both sides of the paper layer.

The paper-component thus may comprise coating(s) (for example, conventional paper surface coatings used in the manufacture of paper), as is well known in the art of paper making (i.e., not including ink and overlacquer). The paper component may or may not comprise such conventional paper coatings. If present such conventional paper coatings are comprised by the paper content of the paper-based packaging film.

Suitably, any surface treatments and coatings, if present, are selected that they do not interfere with recyclability in a standard paper recycling process, specifically not with repulpability. Coatings, if present, are preferably selected so that they do not interfere with recyclability in a standard paper recycling process. In preferred embodiments, the paper component is not mass treated with components that may interfere with recyclability in a standard paper recycling process. The paper component preferably does not comprise conventional grease resistance coatings and mass treatments based on silicones, PVCD and fluoroalkyls and waxes. The paper component, as described herein, preferably does not include non-repulpable paper, or paper that has been mass treated, for example with a wet strength treatment. Examples of non-repulpable paper that would not be useful in the paper-based packaging films described herein include, but are not limited to, parchment papers, two-side wax treated papers, papers combined with sticky adhesives or siliconized papers.

Examples of paper types that may be suitable for use in paper-based packaging film include but are not limited to, kraft paper, bleached paper and micro-fibrillated paper (for example, MFC paper). Hence, the paper component may comprise paper selected from kraft paper, bleached paper and micro-fibrillated paper.

Specific examples of surface treated papers suitable for use in the present invention are clay coated papers, such as one-side clay coated paper (C1S) or two-side clay coated paper (C2S).

Examples of commonly used paper types in packaging that would be acceptable in the paper-based packaging films described herein thus may include machine glazed bleached kraft paper (MGBK), one-side clay-coated paper (C1S) and two-side clay-coated paper (C2S) although less common papers providing improved mechanical or barrier performance by using specialty fibers or additives could also be a part of the paper-based packaging films described herein.

The paper-based packaging film can be described as having a first major outer surface and a second major outer surface. Preferably, the first major outer surface comprises one or more first surface regions provided by the patterned sealable material and one or more second surface regions provided by the paper component. In embodiments, the paper-component can be described as having a top side and a reverse side opposite the top side, wherein the top side comprises said one or more second surface regions and wherein the one or more second surface regions independently comprise one or more of paper (i.e., cellulose fibers), surface treatment(s), ink and over lacquer. In certain embodiments, the reverse side is uncoated and/or untreated. A specific example of a suitable paper component comprises a supercalendered, reverse side untreated, top side uncoated, machine finished paper layer.

The paper component may comprise grease-proof paper. Greaseproof paper is paper that is impermeable to grease (i.e. fats (including oils), fat derivatives and fatty acids), and is normally used in cooking or food packaging. It is usually produced by refining the paper stock to yield a sheet with very low porosity. This is can be subsequently passed between hard pressure rollers (supercalendered) to further increase the density, creating a paper called glassine. The glassine can be treated with PVOH, starches, alginates and/or carboxymethyl cellulose (CMC), for example in a size press to fill surface pores.

The paper selected may provide grease barrier properties without diminishing its recyclability in a standard paper mill. Specifically, this may be achieved by the use of microfibrillated paper or paper which has been coated with greaseproof coatings. Typical grease proof coatings used in the industry and also useful herein are e.g.: PVOH, starch and/or carboxymethyl cellulose (CMC) and alginate based. For example, the paper may be selected to provide oil and grease resistance equal to or less than about 4 as measured by “TAPPI-454 Turpentine Test for Grease Resistance of Paper”, in which turpentine is replaced by Crisco Pure Vegetable Oil run at a temperature of 140° F. for 24 hours at TAPPI conditions. Specifically, when the product is a product containing grease, for example a bouillon cube, the paper is most suitably selected from greaseproof papers.

The paper component can optionally comprise ink and/or over lacquer in addition to a paper layer and optional conventional paper surface treatments, if present. Ink and overlacquer, if present, are not comprised by the paper content of the paper-based packaging film.

Each of the ink and/or overlacquer may be independently continuous with the other layers of the film or independently discontinuous (i.e., patterned). In embodiments, the overlacquer is discontinuous (i.e., a patterned overlacquer), and the patterned overlacquer and the patterned sealable material occupy complementary portions of the first major surface of the packaging film.

The ink can comprise pigments and varnish or a water-based lacquer base. The overlacquer can comprise varnish or a water-based lacquer base. The overlacquer typically does not comprise pigments. The same or different varnish or water-based lacquer can be used for the ink and the overlacquer.

Hence, in embodiments, the one or more second surface regions independently comprise one or more of paper (i.e., cellulose fibers), optionally surface treatment(s), ink and over lacquer.

The paper-based packaging film may comprise ink and/or overlacquer located on the first major outer surface. The ink and/or overlacquer may (independently) cover part or all of the first major surface. Hence, in relation to the package in which the film is to be used, the packaging film may also include ink and/or overlacquer located on the exterior surface of the paper-based packaging film.

In some embodiments, the paper-based packaging film includes an ink layer located on the exterior surface of the paper component. A lacquer coating (overlacquer) may be in direct contact with the ink layer. In some embodiments, a patterned sealable material is located adjacent to the lacquer coating, and on the surface of the lacquer coating opposite the ink layer. The exterior surface of the paper-based packaging film may be formed by both the lacquer coating and the patterned sealable material. In the regions of the patterned sealable material, the exterior surface is the sealable material and the exterior surface is lacquer coating in other regions.

In some embodiments, the packaging film may also include ink located on the exterior surface of the paper-based packaging film. The ink may be in direct contact with the paper component and have a lacquer coating that is in direct contact with the sealable material, such that the ink may be located between the paper component layer and the sealable material. The type of ink and amount of ink can be varied within ranges agreeable with local paper recycling guidelines. The ink can comprise pigments and/or dyes as is known in the art.

Ink and/or overlacquer may be applied to the first major surface (i.e., the exterior surface) by any known printing method including, but not limited to, flexographic gravure printing, rotogravure printing, gravure coating, and digital printing methods.

### Polymeric Film

The paper-based packaging comprises a polymeric film. Advantageously, the polymeric film is very thin. The polymeric film may have a thickness greater than or equal to 2 micron, greater than or equal to 3 micron or greater than or equal to 4 micron. The polymeric film may have a thickness less than or equal to 15 micron, less than or equal to 10 micron, less than or equal to 9 micron or less than or equal to 8 micron. For example, the polymeric film may have a thickness in a range of from greater than or equal to 2 micron to less than or equal to 10 micron, or in a range of from greater than or equal to 2 micron to greater than or equal to 8 micron. Preferably, the polymeric film has a thickness in a range of from 4 micron to 8 micron.

The polymeric film may comprise a monolayer or multilayers. Monolayers comprise one building block (i.e., layer) of one or more polymer(s). Multilayers can comprise one or more of the same or different polymer(s) in multiple building blocks (i.e., layers).

The polymeric film can comprise or consist of oriented or unoriented film(s). The orientation can be in machine direction (MD) in transversal direction (TD) or biaxially (BO), i.e., in machine direction and in transversal direction. For achieving a thin polymeric film having good barrier properties it can be beneficial to use oriented polymeric films, preferably biaxially oriented polymeric films. Processes for subjecting a polymeric film to orientation are well known in the art.

Suitable polymeric materials constituting the polymeric film are not particularly limited and can be selected from a wide range of polymeric materials known for packaging purposes. Suitable materials can for example be selected from one or more of polypropylene (PP), polyester, for example PET, polyethylene (PE), polyamide (PA) and polylactic acid (PLA).

For example, the one or more layers of the may be independently selected from monoaxially oriented polypropylene (OPP, MD or TD, preferably MD) film(s), biaxially oriented polypropylene (BOPP) film(s), monoaxially oriented polyethylene (OPE, MD or TD) film(s), biaxially oriented polyethylene (BOPE, MD or TD) film(s), monoaxially oriented polyester (MD polyester or TD polyester, for example OPET, MD or TD) film(s), biaxially oriented polyester film(s), for example BOPET film(s), monoaxially oriented polyamide (OPA, MD or TD) film(s), biaxially oriented polyamide (BOPA) film, monoaxially oriented polylactic acid (OPLA, MD or TD) film(s), and biaxially oriented polylactic acid (BOPLA) film(s). In some embodiments, a biaxially oriented polypropylene film is used.

The polymeric film may be an unoriented material such as, but not limited to, unoriented PLA.

In some embodiments the second major outer surface is provided by the polymeric film. The interior surface may consist essentially of or consist of the polymeric film.

In some embodiments, the paper component is connected to the polymeric film. The paper component can be connected to the polymeric film as is known the art for example by laminating, with or without the use of an adhesive, as is known in the art.

Preferably, the polymeric film does not extend into the fiber-network of the paper component. In the present disclosure, it is preferred that the polymeric film is not coated onto the paper component. Coating polymeric materials onto a paper structure may cause the coating material to penetrate into and attach to the fiber network, which in turn can result in difficult-to-separate composite fiber-polymer structures and pulp losses in a recycling process.

### Patterned Sealable Material

The paper-based packaging film comprises at least one patterned sealable material.

As used herein, the term “patterned” means that the layer of sealable material is discontinuous with the paper-based packaging film. The sealable material is discontinuous with the paper component upon which it is applied. For example, the patterned sealable material may be applied over greater than or equal to 5%, greater than or equal to 10%, or greater than or equal to 15% of the surface of the paper component. The patterned sealable material may be applied over less than or equal to 30%, less than or equal to 25%, or less than or equal to 20% of the paper component, as an example. Without intending to be bound by theory, it is thought that using a patterned sealable material helps with recycling and lowers material use.

As a result, the first major surface of the paper-based packaging film is partially the paper component surface (which may optionally comprise ink and/or overlacquer as described herein) and partially the sealable material.

For example, the first major surface of the paper-based film may be approximately 80% paper (with or without ink and/or overlacquer) and 20% patterned sealable material.

In other words, the patterned sealable material (e.g., the layer of patterned sealable material) covers only some portion of the area of the multilayer packaging film (e.g., of the first outer major surface of the paper-based packaging film).

In embodiments, the first major outer surface of the paper-based packaging film comprises one or more first surface regions provided by the patterned sealable material. In embodiments, the first major surface also comprises one or more second surface regions provided by the paper component (and optionally including ink and/or overlacquer). In other words, the first major surface comprises each of the paper component (and optionally including ink and/or overlacquer) and the patterned sealable material. In typical embodiments, the one or more second surface regions occupy complementing areas to the one or more first surface regions on the first major outer surface of the paper-based packaging film. The first surface regions may comprise greater than or equal to 5%, greater than or equal to 10%, or greater than or equal to 15% of the first major outer surface of the paper-based packaging film. The first surface regions may be applied over less than or equal to 30%, less than or equal to 25%, or less than or equal to 20% of the first major outer-surface of the paper-based packaging film.

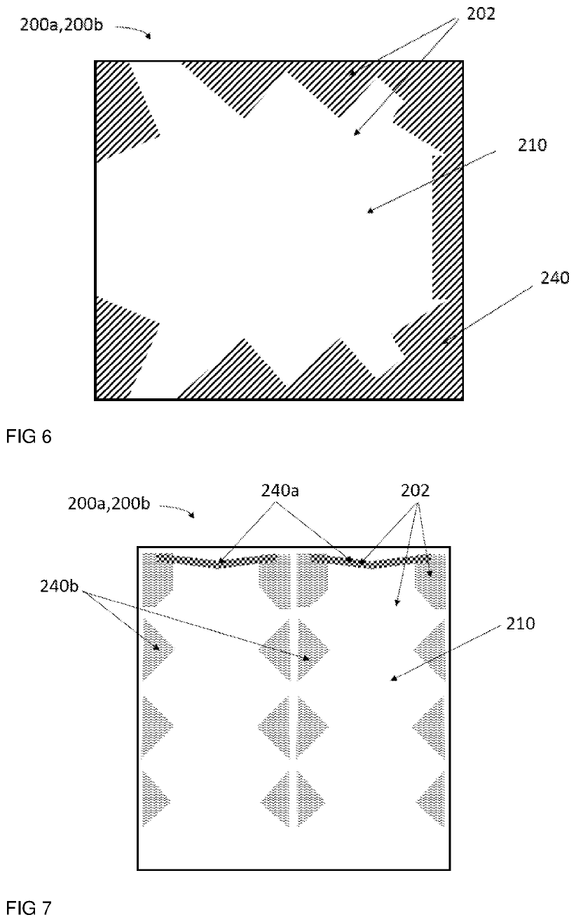

The first surface regions can have one or more interconnections. For example, the location(s) of the first surface region(s) on the first major outer surface can be selected to provide a fully or partly connected first surface region on the paper-based packaging film (or a sheet thereof), such as a U-shape, V-shape, W-shape, O-shape, a square, rectangular or other polygonal configuration or a ring configuration. The locations of the one or more first surface regions can be selected to provide a fully or partly circumventing configuration on the first major outer surface of the paper-based packaging film (or a sheet thereof), for example one as shown in FIG. 6.

The patterned sealable material may be applied to areas of the paper-based packaging film that are involved with closing the package by sealing. When formed into a package, the first major surface becomes the exterior surface and is used for forming seals, bonding with another part of the paper-based packaging film that overlaps the first surface region of the first major outer surface (referred to herein as overlapping parts).

Hence, although the location of the first surface regions can be freely selected, the one or more first surface regions may typically be located in those areas of the first major outer surface of the paper-based packaging film (or a sheet thereof) that form overlapping parts when the paper-based packaging film (or sheet thereof) is formed into a three-dimensional package. The overlapping parts can vary based on the package formation process and the packaging machine used. For example, when forming the paper-based packaging film (or a sheet thereof) into a package by folding around a product such as a cuboid product, the folding sequence used can determine which regions of the first major outer surface of the packaging film are involved in creating overlapping parts. Hence, the configuration of the one or more first surface regions on the first major outer surface can vary depending on the product to be wrapped and depending on the folding sequences used. The other parts of the paper-based packaging film that overlap the first surface region of the first major outer surface when forming a package can comprise parts on the first major surface and/or on the second major surface of the paper-based packaging film. In other words, overlapping parts can comprise the same type of surface (for bonding that type of surface to itself) or different types of surfaces (for bonding different types of surfaces to each other). Overlapping parts include at least patterned sealable material and optionally one or more parts selected from second surface regions (i.e., paper component optionally including ink and/or overlacquer), second major outer surface of the paper-based packaging film (i.e., polymeric film in embodiments) and combinations thereof. Hence, overlapping parts may comprise patterned sealable material (e.g., in areas of the first surface regions) and one or more of 1) another area of the first surface regions including patterned sealable material (i.e., for sealing to itself), 2) areas of the second surface regions (i.e., for sealing to paper, optionally to ink and/or overlacquer, if present) and 3) the second major outer surface (i.e., for sealing to the polymeric film). Depending on the application, the patterned sealable material may be selected to provide adhesion between the same or different types of surfaces.

Overlapping part(s) typically include at least a portion (such as 60% or more, 70% or more, 80% or more, 90% or more or even 100%) of the first surface regions (i.e., on the first major outer surface of the paper-based packaging film, which becomes the exterior surface of the paper-based packaging film when formed into a package) and may further include a portion of the second surface regions of the first major outer surface of the paper-based packaging film (i.e., as provided by the paper component) and/or a portion of the second major outer surface of the paper-based packaging film (the surface becoming the interior surface of the packaging film upon forming the package, which is provided by the polymeric film in typical embodiments).

In the present invention, the patterned sealable material can comprise one or more different patterned sealable materials. The one or more first surface regions may be provided by one patterned sealable material. The one or more first surface regions may also be collectively provided by two or three or even more different patterned sealable materials, i.e., by more than one patterned sealable materials which differ from each other in at least one aspect(s). The difference(s) may be based on one or more aspects including, for example, the adhesive category (for example, heat seal (lacquer), hot melt, cold seal), the chemical composition and the pattern of the sealable material.

The patterned sealable material (and the first surface regions in embodiments) can form any suitable pattern, such as any suitable drawings, graphics, and/or textual terms, and/or define a pattern having any suitable shape or shapes, including, but not limited to, dots, points, lines, crossed-lines, diamonds, or checkerboards. The patterned sealable material may accentuate the overall appearance of the packaged product.

In embodiments involving two or more different types of patterned sealable materials, the one or more first surface regions can for example comprise a first patterned sealable material and a second patterned sealable material. The first patterned sealable material and the second sealable material may collectively provide the one or more first surface regions. The first and second patterned sealable materials can be provided in mutually exclusive areas of the first surface regions and/or in the same areas of the first surface regions. The first and second patterned sealable materials can be provided by sealable materials of two different adhesive categories. For example, the first sealable material can be selected from among heat seal lacquers and hot melt materials, and the second sealable material can be selected from among cold seal materials, or vice versa. The first and second patterned sealable materials can provide the same or different patterns. For example, the two patterned sealable materials may be applied over collectively greater than or equal to 5%, greater than or equal to 10%, or greater than or equal to 15% of the surface of the first major outer surface of the paper-based packaging film. The two patterned sealable materials may be applied over collectively less than or equal to 30%, less than or equal to 25%, or less than or equal to 20% of the first major surface of the paper-based packaging film, for example.

In embodiments, the paper-based packaging films can be described as including a patterned sealable material as an outer (typically discontinuous) layer at the exterior surface. The exterior surface of the paper-based packaging film (also referred to herein as the first major outer surface) is partially the paper component (or paper layer) surface and partially the sealable material (plus optionally ink and/or overlacquer, if present).

The adhesive category of the patterned sealable material is not particularly limited and can be selected from among categories of sealable materials typically used in packaging structures. The category of sealable material may be selected based on the requirements of the specific packaging application, the product to be packaged (considering for example, the heat sensitivity of the product) and depending on which overlapping parts of the paper-based packaging film are involved for forming seals in the packaging application concerned. For example, the category of sealable material may be selected depending on which parts on the two major outer surfaces of the paper-based packaging film are involved in creating overlapping areas for forming seals upon forming the package from the paper-based packaging film. Seals involve at least the patterned sealable material and may additionally involve one or more other elements of the paper-based packaging film, such as parts of the second major surface regions (provided by the paper component, optionally including ink and/or overlacquer) and/or (parts of) the second major outer surface (provided by the polymeric film in typical embodiments). Hence, seals may be formed between the same or different kinds of materials, such as between sealable material to itself, or between different kinds of material, such as sealable material to paper component (or ink and/or over lacquer) and/or second major outer surface (i.e., to the polymeric film in typical embodiments). Seals may also involve two or more different types of patterned sealable material, if used.

The patterned sealable material is used for forming bonds when forming a package, which may be hermetically sealed or not, depending on the packaging application. The first surface regions may be configured to provide a sealed package, such as a hermetically sealed package or a package that is not hermetically sealed.

Suitable categories from which the patterned sealable material can be selected may be broadly divided into cold sealable materials or “cold seals” and heat sealable materials or “heat seals” (including hot melts). The sealable material can be applied from suitable physical forms as is known in the art.

The patterned sealable material can be or incorporate a cold sealable material. The sealable material may have a composition that will allow the formation of a cold seal. Cold seals as used herein do not require heat (i.e., temperatures above 50° C.), solvent or water to activate the sealable material to form a bond, i.e., they are typically non-reactive adhesives. Typically, a temperature range including ambient temperature of the place in which the packaging unit is located is suitable for forming cold seals, such as 15° C. to 30° C., as an example.

Cold seals can be useful for providing one or more self-seal area(s) on the first major surface of the paper-based packaging film (i.e., upon forming into a package). Cold seals may only require (typically light) pressure to seal, i.e., to bond the cold seal material with a surface in an overlapping part. Using cold seals can also provide benefits in terms of packaging speed.

The patterned sealable material may be a pressure sensitive cold seal material. This embodiment of the paper-based packaging film is advantageous as formation of the package does not require heat. Without intending to be bound by theory, the pressure sensitive cold seal may be advantageous for the packaging of heat sensitive products such as products containing low-melting fats. Embodiments of the paper-based packaging film may include a pressure sensitive cold seal system including, but not limited to, natural or synthetic polyisoprene latex, or styrene butadiene copolymer latex. The cold seal material may comprise blends that include acrylates and/or tackifiers.

Alternatively, the patterned sealable material can be or incorporate a heat sealable material. The heat sealable material can be applied from any physical form, for example from a heat seal lacquer or hot melt adhesive.

The paper-based packaging film may incorporate a sealable material that is heat sealable, e.g., a heat seal lacquer or a hot melt adhesive. The sealable material of the paper-based packaging film may have a composition that will allow the formation of a heat seal. As used herein, the term “heat seal”, “heat sealable” or “heat sealed” refers to two or more surfaces that have been or can be bonded together by application of both heat and pressure. Heat sealing is a well-known and commonly used process for creating packages and is familiar to those skilled in the art. Without intending to be bound by theory, during heat sealing, the sealing material softens due to the application of heat, allowing formation of a heat seal bond. Since the heat must be driven through the entire paper-based packaging film to raise the temperature of the sealable material, and the paper component often absorbs much of the heat, it is advantageous if the heat sealable material softens and seals at a relatively low temperature. Lower seal initiation temperature (SIT) enables faster packaging line speeds. For example, some embodiments of the paper-based packaging film may include a heat sealable material that exhibits an SIT of less than or equal to 110° C., less than or equal to 100° C., or less than or equal to 90° C. Possible heat sealable materials may include, but are not limited to, acrylate copolymers, PET, PE, PP, or EVA copolymers. Such materials can be provided from a lacquer, as is known in the art.

Suitable heat sealable materials can also be selected from hot melts. Hot melts or hot melt adhesives are well known in the art of packaging. Hot melts are brought to liquid form with heat and can be applied by coating the desired portions before the hot melt material cools into a solid polymer. They rely on cooling to set (versus evaporation as in the case of a heat seal or cold seal lacquer). Suitable hot melt adhesives my include but are not limited to EVA-based, amorphous poly-α-olefin-based (APAO) hot melt adhesives. Suitable hot melts can also include pressure sensitive hot melts. Hot melts, usually have a composition formulated to have a glass transition temperature (onset of brittleness) below the lowest service temperature and a suitably high melt temperature as well. The degree of crystallization should be as high as possible but within limits of allowed shrinkage. The melt viscosity and the crystallization rate (and corresponding open time) can be tailored for the application. Hot melt adhesives have a quick set speed and are applicable in a wide range of temperature.

The sealable material can be applied as a lacquer or from a water-based dispersion. For example, the heat sealable may comprises a water-based dispersion based on EVA-copolymer resin.

The patterned sealable material can be applied by any suitable method, such as by printing, using for example any known printing method including, but not limited to, flexographic gravure printing, rotogravure printing, gravure coating, and digital printing methods.

The sealable material is applied at a thickness that allows for sealing in a chosen application. In some embodiments, the sealable material may be applied at a basis weight of greater than or equal to 1 g/m² or greater than or equal to 3 g/m². In other embodiments, the sealable material may be applied at a basis weight of less than or equal to 8 g/m², less than or equal to 9 g/m², or less than or equal to 10 g/m². For example, the sealable material may have a basis weight in a range of from about 1 g/m² to about 10 g/m², or in a range of from about 3 g/m² to about 9 g/m².

### Barrier Material

The paper-based packaging film can further comprise a barrier material. In some embodiments, the barrier material is located between the paper component and the polymeric film. In some embodiments, the polymeric film includes a topcoat between the barrier material and the paper component. The topcoat may be directly applied to the barrier material.

The paper-based packaging film according to any previous claim wherein each of the paper component, the polymeric film and the barrier material, if present, are fully coextensive with each other.

The barrier material is not particularly limited and can be selected from organic and inorganic barrier materials known in the art. The barrier material may be a blend of multiple barrier materials. The barrier material may be comprised in a mono layer or may be comprised in a multi-layer and contain different layers of barrier materials.

For example, the barrier material can be selected from a metal (for example aluminum), an inorganic oxide (for example AlOx in which AlOx refers to oxides of aluminum having the formula AlyOz where the ratio y/z is a number from 0.2 to 1.5, preferably y is 2 and z is 3 (i.e., Al2O3)); or SiOx, where x is a number from 1 to 2, preferably from 1.5 to 1.8 (i.e., SiOx in which 1≤x≤2, preferably in which 1.5≤x≤1.8) or a combination thereof. These barrier materials are applied to the polymeric film by vapor deposition type processes, as is known in the art, and the thickness of these barrier materials is negligible (i.e., less than 1 micron or less than 0.5 micron) with respect to the packaging film.

The barrier material may also be polymeric in nature and can be selected from polymeric barrier materials such as polyamide, ethylene vinyl alcohol copolymer or polyvinyl alcohol copolymer.

The barrier material preferably provides a layer having a maximum thickness of equal to or less than 1 microns, preferably equal to or less than 0.5 microns.

In preferred embodiments, the barrier materials are not applied to the paper component. Applying the barrier material to the paper component can interfere with recyclability. The barrier material is suitably applied to the polymeric film. The barrier material may be coated directly onto the polymeric film, or there may be a primer layer between the barrier material and the polymeric film.

Some embodiments of the paper-based packaging film can be described as having an exterior surface and an interior surface, a polymeric film, the polymeric film being any oriented or unoriented film, optionally but preferably including any metal or oxide barrier coating, a paper component, and a patterned sealable material. In embodiments, the barrier coated side of the polymeric film is attached to the paper component by an adhesive, such as a water-sensitive adhesive. In one or more embodiments, the interior surface comprises a polymeric film, and the exterior surface comprises each of the paper component and the patterned sealable material, comprising a polymeric barrier film, wherein the polymeric barrier film is an oriented or unoriented film having a metal or oxide coating and wherein optionally the barrier coated side of the polymeric film is attached to the paper component by an adhesive.

Combinations of polymeric film and barrier material that have been found to be useful in the paper-based packaging films include SiOx coated OPET and BOPET, SiOx coated OPP and BOPP, AlOx coated OPET and BOPET, AlOx coated OPP and BOPP, aluminum metal coated OPET and BOPET and aluminum metal coated OPP and BOPP and in particular combinations of polymeric film and barrier material selected from SiOx coated OPET, SiOx coated BOPP, AlOx coated OPET, AlOx coated BOPP, aluminum metal coated OPET and aluminum metal coated BOPP.

The barrier material may provide reduced transmission of oxygen, moisture or both oxygen and moisture.

In some embodiments, the paper-based packaging film containing a barrier material and a polymeric film (for example, containing a barrier material coated on a polymeric film) has an average oxygen transmission rate (OTR) value that is less than or equal to 5 cm³/m²/day, less than or equal to 1 cm²/m²/day or less than or equal to 0.5 cm²/m²/day measured according to ASTM F1927 using conditions of 1 atmosphere, 23° C. and 50% RH.

In some embodiments, the paper-based packaging film containing a barrier material coated on a polymeric film has an average moisture vapor transmission rate (MVTR) value that is less than or equal to 1 g/m²/day, or less than or equal to 0.3 g/m²/day measured according to ASTM F1249 using conditions of 1 atmosphere, 38° C. and 90% RH.

### Adhesive

The paper-based packaging film may further comprise an adhesive. For example, the adhesive may be located between the paper component and the polymeric film or between the paper component and the barrier material if present. The adhesive and the at least one patterned sealable material may be comprised of the same or of a different material. For example, in typical embodiments, the patterned sealable material and the additional optional adhesive are comprised of or provided by different materials. For example, the patterned sealable material is provided by a heat sealable material and the adhesive is provided by a material different to that, such as by a water-sensitive adhesive.

The adhesive may provide an adhesive layer bonding the paper component to the polymeric film or to the barrier material, if present. The adhesive may be in direct contact with the paper. The adhesive may be in direct contact with the polymeric film. The adhesive may be in direct contact with the barrier layer, if present. The adhesive may be applied by any known means of web-to-web lamination, such as dry bond lamination, wet bond lamination or heat lamination. The adhesive may have a dry basis weight (i.e., after solvent removal) of between 0.5 g/m² to 8.0 g/m² or of between 0.5 g/m² and 4.0 g/m².

The adhesive may be advantageously selected so as not to interfere with fiber release from the paper component in a paper recycling process.

In advantageous embodiments, the adhesive comprises a material that is water-sensitive. Embodiments of the disclosure advantageously provide paper-based packing films including an adhesive layer having an adhesive that is water sensitive. As used herein, the term “water sensitive” means that upon prolonged exposure to or immersion in liquid water, the adhesive loses its adhesive and/or cohesive properties. Hence, use of a water-sensitive adhesive thus enabling the delamination (i.e., separation) of the paper component from the rest of the paper-based packaging film structure during a repulping process. The adhesive may be a water-based adhesive, formulated using synthetic and/or natural based polymers. Examples of materials that may be used within an adhesive layer between the paper component and the barrier layer include, but are not limited to, latex/casein blends, starch, sugar derivatives, cellulose, amino resin, (poly) acrylate, polyvinyl alcohol (PVOH), polyvinyl acetate, polyacrylic acid, maleic acid-modified ethylene copolymers, methylcellulose, carboxy-methylcellulose, carboxy-functional polyesters, polyethylene succinate, polybutylene succinate, ionomers or hydrophilic polyurethane.

Solvent based/solvent free adhesives are not preferred for use in the present invention as they typically may cause significant issues during recycling as they are absorbed into the fibrous cellulose matrix and after curing form an insoluble layer. However, some combinations of paper and solvent based/solvent free adhesives can cause minimal fiber loss during recycling as they only interact on the surface or with a small set of fibers. Hence, such adhesives may still be used in the invention in certain embodiments. Water-sensitivity can be established using a standard laboratory pulp disintegrator using water, 40°+/−5° C. water and 30,000 rotations. Preferably, a suitable adhesive does not interfere with recycling in a standard paper recycling process, as determined according to the recyclability standards described herein.

### Manufacture

The paper-based packaging film can be obtained by methods known in the art of packaging films. A suitable method can for example include providing a paper component, providing a patterned sealable material on the first major surface of the paper component, providing a polymeric barrier film, and connecting the second major surface of the paper component to the polymeric barrier film by methods known in the art, such that the first major surface of the paper component provides an outer surface of the packaging film. In embodiments the method provides the polymeric film as a second major outer surface of the paper-based packaging film. Connecting can be accomplished by methods known in the art, such as by laminating with or without intervening materials (using for example a water-sensitive adhesive, as described herein). The method can additionally comprise applying a barrier material on the surface of the polymeric film and connecting the polymeric film and the paper material such that the barrier material is located between the paper component and the polymeric film.

The method can also comprise cutting the packaging film into separate sheets designed for a packaging application which can have any form. Suitable sheets can for example be designed for packaging for wrapping for example for use with an article to be wrapped. The sheet can also be in the form of a cut-out adapted to the geometry of the product to be packaged and/or the packaging machine used. A suitable sheet can be rectangular or have an opened envelope-form, for example.

### Uses

The packaging material disclosed herein is suitable for packaging various types of products, including food and non-food products. The packaging material is particularly suitable for packaging food products. It has been found that the packaging material described herein is particularly useful for packaging products having a cuboid shape. It has also been found that the packaging material described herein is particularly useful for packaging food products such as those containing grease, including products such as bouillon cubes or stock cubes, confectionary or chocolate.

Hence in embodiments, the present invention relates to a paper-based packaging film for packaging cuboid food products, e.g., bouillon cubes or stock cubes. The term “stock cube” is known in the art and refers to a type of product. In the context of the present invention, it is not necessarily limited to and should not be construed as a product to prepare only a bouillon, or stock, but it might be suitable for preparing a bouillon, soup, sauce, gravy or for use as a seasoning. As such, the stock cube is usually diluted, at least partly, in a hot aqueous solution, like water, or the product is crumbled, at least partly over a dish during preparation, e.g., in a cooking pot, or before consumption, e.g., on the plate of the consumer.

In embodiments, the product can be a food product comprising one or more components selected from grease, salt, sugar, food concentrates, dried food components and spices.

Food products to be packaged include but are not limited to for example grease containing food products, food concentrates, spice blends, seasoning, and dried food blends. A particular field of application is for packaging bouillon cubes or stock cubes. The packaging film described herein is, however, also useful for packaging other types of products, such as non-food products, for example tobacco or soap.

The products to be packaged can be in any form, such as in loose or pressed powder form, concentrate form, loose or pressed particulate form, loose or pressed fiber form, loose or pressed shredded form, semisolid form or shaped form. The pressed form can have any shape suitable for packaging such types of products.

A particularly suitable shape is a cuboid shape. The cuboid may be of any size or cuboid shape. The packaging materials is particularly useful for forming a cuboid package, such as a packaging for bouillon cubes.

The present invention is however not limited to this particular use, but the packaging material is useful in itself, and can for example be used for wrapping products of any shape or for lining secondary packages or parts thereof (i.e., without necessarily providing a packaged cuboid product). The term “secondary packages” as used in this context means that the secondary package must not be made of the packaging film described herein, although this is not excluded.

### Package

The present invention also relates to packages formed from or including paper-based packaging films as described herein. The packages can be sealed by the patterned sealable material. In the packages the patterned sealable material is typically facing away from the product and typically facing towards the environment.

The package is typically formed by sealing. Sealing can include bonding the patterned sealable material to itself (i.e., in overlapping parts) or to another surface portion on the paper-based packaging film (i.e., in overlapping parts), such as in overlapping parts including one or more of second surface regions (provided by the paper component, optionally including ink and/or over lacquer) and second major outer surface of the paper-based packaging film (which is provided by the polymeric film in typical embodiments).

In embodiments, the package is a fold package formed from a paper-based packaging film as described herein, for example by fold wrapping the paper-based packaging film around the product to be packaged, for example a cuboid product. The fold package may be of any size or shape, such as cuboid of any size and cuboid shape. The fold package typically comprises a packaged product.

Fold wrapping typically comprises tightly wrapping the packaging film around the product to be packaged along fold lines, as is known in the art. A typical folding operation can include a sequence of folding steps so as to create at least two superimposing fold regions (i.e., overlapping parts) which can be superimposed on each other and used for sealing with the patterned sealable material so as to form permanent and stable fold wrapping. The patterned sealable material is located on the side of the paper-based packaging film facing away from the product.

For example, a product can be individually wrapped using a sheet of the paper-based packaging film of an appropriate size and shape (for example a rectangular sheet adapted to the size of the product to be packaged). The product to be wrapped, which for example, may be of a cuboidal shape, is typically placed in the center of the second major outer surface of the paper-based packaging film. The first major surface of the paper-based packaging film is facing away from the product and towards the environment. Depending on the orientation of the article on the sheet and the folding sequence selected, one or more sides of the sheet are turned up or down along the three-dimensional shape of the article to be packaged creating overlapping areas in one or multiple folding steps. The patterned sealable material may help to hold the fold structure in place during the packaging process. The patterned sealable material provides bonds in overlapping areas of the paper-based packaging film, as described with respect to the paper-based packaging film. In embodiments, folds may be secured by applying light pressure and by the mutual superposition of certain regions having a sealable material (i.e., in overlapping parts).

The patterned sealable material may provide a hermetically sealed package, although this is not a requirement. Hence, the package may be a hermetically sealed package or a not hermetically sealed package.

In some embodiments, the present invention provides a packaged cuboid product comprising: a paper-based packaging film as described herein and a product having a cuboid shape; wherein the paper-based packaging film is wrapped around the product such that the first major surface of the packaging film is facing away from the product. The packaged cuboid product may comprise a paper-based packaging film as described herein and wherein the second major surface comprises the polymeric film and is facing the product. The second major surface may be in contact with each side of the product.

The packaged cuboid product can comprise an individually wrapped product having a cuboid shape. Alternatively, the packaged cuboid product can comprise a cuboid block product consisting of multiple separable cuboid compartments and the paper-based packaging film is wrapped around the cuboid block product.

The packaged cuboid product is sealed by the patterned sealable material.

### DETAILED DESCRIPTION OF THE DRAWINGS

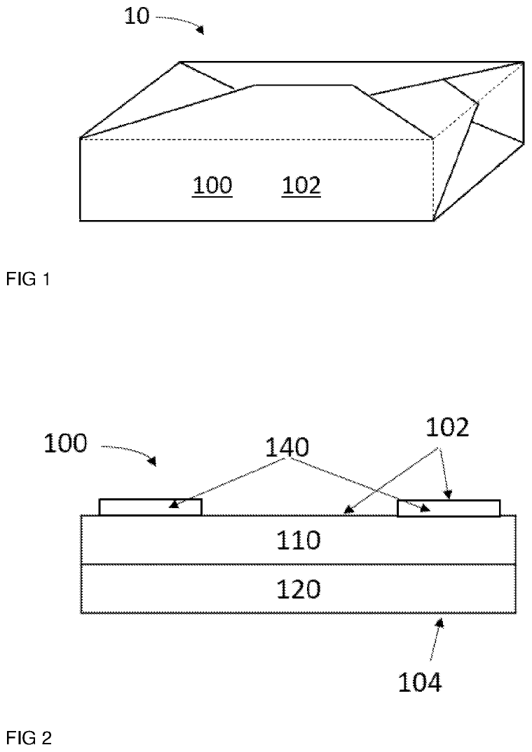

FIG. 1 is a perspective view of an embodiment of a packaged cuboid product 10. The paper-based packaging film 100 with first major outer surface 102 forming an exterior surface and facing away from the product is wrapped around the cuboid product (not shown) and sealed closed where the edges fold over the top. The packaged cuboid product may be of any size or cuboid shape.

FIG. 2 is an embodiment of a cross-sectional view of a paper-based packaging film 100. The packaging film 100 includes a paper component or paper layer 110, and a polymeric film 120. The paper-based packaging film 100 also includes a patterned sealable material 140 located on the surface of the paper component or paper layer 110. In this configuration, the polymeric film 120 is located at the second major surface of the packaging film (the interior surface) 104 and the patterned sealable material 140 and the paper component or paper layer 110 are located at the exterior surface 102. In some embodiments, the polymeric film 120 forms an inner layer (i.e., provides the second major outer surface), the outer layer located at the interior surface 104 of the paper-based packaging film 100. In some embodiments, the polymeric film 120 is adhered to the paper component or paper layer 110 by an adhesive (layer) 150 (not shown). In some embodiments, a patterned sealable material 140 is located adjacent to the paper component or paper layer 110, and on the surface of the paper component or paper layer 110 that is opposite the adhesive (layer) 150 (not shown). The exterior surface 102 of the paper-based packaging film 100 is formed by both the paper component or paper layer 110 and the patterned sealable material 140. In the regions of the patterned sealable material 140, the exterior surface 102 is the patterned sealable material and the exterior surface 102 is the paper component or paper layer 110 in other regions.

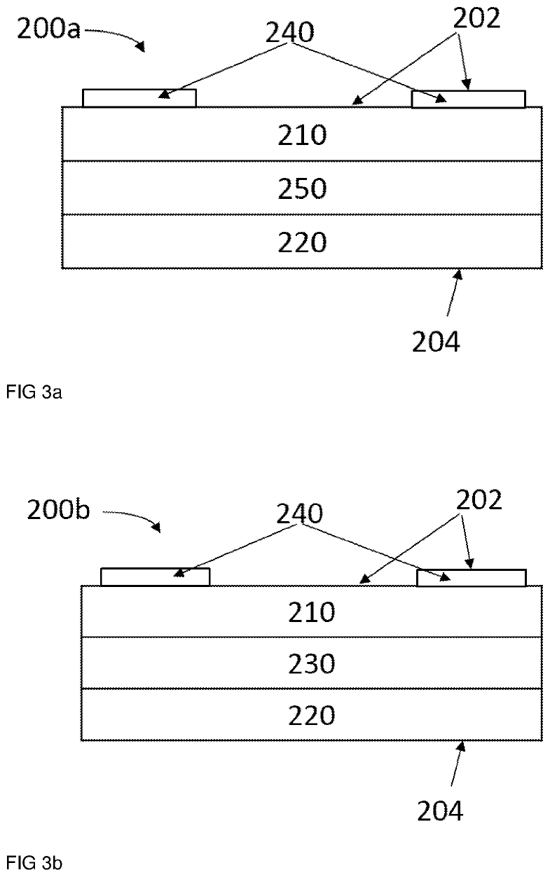

FIG. 3a is another embodiment of a cross-sectional view of a paper-based packaging film 200a. The packaging film 200a includes a paper component or paper layer 210, an adhesive 250 and a polymeric film 220, in that order. The adhesive preferably attaches the paper component or paper layer 210 to the polymeric film 220. The paper-based packaging film 200a also includes a patterned sealable material 240 located on the surface of the paper component or paper layer 210. In this configuration, the polymeric film 220 is located at the second major surface (interior surface) 204 and the patterned sealable material 240 and the paper component or paper layer 210 are located at the first major surface (exterior surface) 202.

FIG. 3b is another embodiment of a cross-sectional view of a paper-based packaging film 200b. The packaging film 200b includes a paper component or paper layer 210, a barrier material 230 and a polymeric film 220, in that order. The barrier material is located between the polymeric film 220 and the paper component or paper layer 210. The paper-based packaging film 200b also includes a patterned sealable material 240 located on the surface of the paper component or paper layer 210. In this configuration, the polymeric film 220 is located at the second major surface (interior surface) 204 and the patterned sealable material 240 and the paper component or paper layer 210 are located at the first major surface (exterior surface) 202.

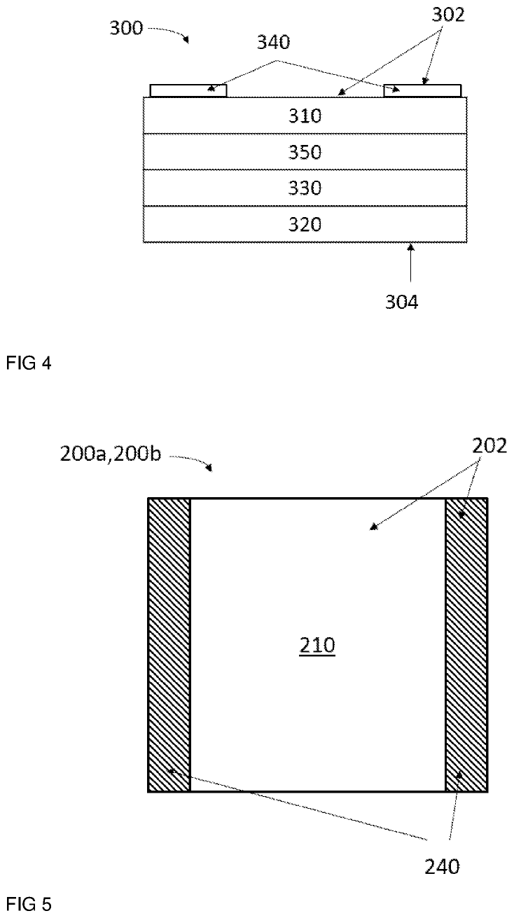

FIG. 4 is another embodiment of a cross-sectional view of a paper-based packaging film 300. The packaging film 300 includes a paper component or paper layer 310, and adhesive 350, a barrier material 330 and a polymeric film 320, in that order. The paper component or paper layer 310 is attached to the barrier material 330 by adhesive (layer) 350. The paper-based packaging film 300 also includes a patterned sealable material 340 located on the surface of the paper component or paper layer 310. In this configuration, the polymeric film 320 is located at the second major surface (interior surface) 304 and the patterned sealable material 340 and the paper component or paper layer 310 are located at the first major surface (exterior surface) 302.

In some embodiments, the polymeric film 320 forms an inner layer (i.e., provides the second major outer surface of the packaging film), the inner layer located at the interior surface 304 of the paper-based packaging film 300. In some embodiments, the barrier material 330 is adjacent to a paper component 310. In some embodiments, the paper component 310 and the barrier material 330 are bonded to each other by an adhesive (layer) 350. In some embodiments, the paper-based packaging film (100, 200a, 220b, 300) includes an ink layer (not shown) located on the exterior surface of the paper component (110, 210, 310). A lacquer coating (over lacquer, not shown) is in direct contact with the ink layer. In some embodiments, a patterned sealable material (140, 240, 340) is located adjacent to the lacquer coating, and on the surface of the lacquer coating opposite the ink layer. The exterior surface (101, 202, 302) of the paper-based packaging film (100, 200a, 200b, 300) is formed by both the lacquer coating and the patterned sealable material (140, 240, 340). In the regions of the patterned sealable material (140, 240, 340) the exterior surface (102, 202, 302) is the sealable material and the exterior surface (102, 202, 302) is lacquer coating in other regions.

FIG. 5 is an exemplary plan view of the exterior surface 202 (or 102 or 302, not shown) of an embodiment of a paper-based packaging film 200a or 200b (or of a paper-based packaging film 100 or 300, not shown). The exterior surface 202 (or 102 or 302, in case of a paper-based packaging film 100 or 300, not shown) consists of the paper component or paper layer 210 (or 110 or 310, in case of a paper-based packaging film 100 or 300, not shown) and the patterned sealable material 240 (or 140 or 340, in case of a paper-based packaging film 100 or 300, not shown). While a specific pattern of sealable material is shown, this material can be in any pattern suitable for the application.

FIG. 6 is another exemplary plan view of the exterior surface 202 (or 102 or 302, not shown) of an embodiment of a paper-based packaging film 200a or 200b (or of a paper-based packaging film 100 or 300, not shown). The exterior surface 202 (or 102 or 302, in case of a paper-based packaging film 100 or 300, not shown) consists of the paper component or paper layer 210 (or 110 or 310, in case of a paper-based packaging film 100 or 300, not shown) and the patterned sealable material 240 (or 140 or 340, in case of a paper-based packaging film 100 or 300, not shown). While a specific pattern of sealable material is shown, this material can be in any pattern suitable for the application.

FIG. 7 is another exemplary plan view of the exterior surface 202 of an embodiment of a paper-based packaging film 200a or 200b (or of a paper-based packaging film 100 or 300, not shown). The exterior surface 202 (or 102 or 302, in case of a paper-based packaging film 100 or 300, not shown) consists of the paper layer 210 (or 110 or 310, in case of a paper-based packaging film 100 or 300, not shown) and two different patterned sealable materials, a first patterned sealable material 240a and a second sealable material 240b (or 140a/140b or 340a/340b in case of a paper-based packaging film 100 or 300, not shown). In the embodiment shown, the first sealable material 240a covers 2.5% of the surface and the second sealable material 240b covers 14% of the surface. While specific patterns of sealable materials are shown, the first and second sealable materials 240a and 240b can each be in any pattern and cover any area suitable for the application. The pattern shown in FIG. 7 is indicative of how one might produce the material in a roll-to-roll format. The shown pattern is a section of the length of the film. The two repeated patterns, side-by-side, would eventually cut apart from each other in order to wrap a product therein. A first sealing material in the 240b sections seals to itself as the packaging film is folded. A second sealing material in the 240a sections seal the package against the exterior surface, sealing the package closed.

Master Terms List: 10 Packaged Cuboid Product; 100, 200a, 200b, 300 Paper-based Packaging Film; 102, 202, 302 Exterior Surface of Paper-based Packaging Film; 104, 204, 304 Interior Surface of Paper-based Packaging Film; 110, 210, 310 Paper Component or Paper Layer; 120, 220, 320 Polymeric Film; 230, 330 Barrier Material; 140, 240, 340 Patterned Sealable Material; 140a, 240a, 340a First patterned Sealable Material; 140b, 240b, 340b Second Patterned Sealable Material; 250, 350 Adhesive.

### Advantages

It has been found that a paper-based packaging film as described herein can solve the problems outlined herein. The packaging films have high barrier properties (in particular, against moisture and grease), good folding properties, and excellent sealing performance, while maintaining recyclability in paper recycling process, such as in a standard paper recycling process. The paper-based packaging films and packages made therefrom are recyclable as determined by at least one, two or all of PTS-RH 021-Cat 2, Aticelca 501 (2019) and CEPI Harmonized European laboratory test method-Version 2. For example, paper-based packaging films as described herein can be graded B, A or A* according to the Aticelca 501 (2019).

To maintain recyclability of the paper-based packaging film, the paper component thickness and/or weight is increased in order to attain the paper content required for designating the packaging material “recyclable.” The packaging films are useful for packaging grease-containing products, while maintaining recyclability in a paper recycling process, such as a standard paper recycling process. Advantageously, the packaging films described herein are able to maintain excellent appearance during packaging converting and package use and storage (for example, they are not susceptible to stains from grease). In addition, the packaging films can be used on high-speed packaging machines, i.e., they have good runnability. The paper-based packaging films perform particularly well in cuboid products and products containing grease including but not limited to bouillon cubes. Upon folding the paper-based packaging film around a bouillon cube product and storing, there were no grease stains, as had been visible on other coated paper structures. The inclusion of the thin polymeric barrier film provided excellent barrier, excellent runnability and recyclability.

### EMBODIMENTS

The present disclosure also extends to the following embodiments:

Embodiment 1: A paper-based packaging film typically having a first major outer surface and a second major outer surface, the paper-based packaging film comprising: a paper component; a polymeric film; and a patterned sealable material. The first major outer surface typically (preferably) comprises one or more first surface regions provided by the patterned sealable material and one or more second surface regions provided by the paper component.

Embodiment 2: A paper-based packaging film according to Embodiment 1 wherein the second major outer surface is provided by the polymeric film.

Embodiment 3: A paper-based packaging film according to any previous embodiment wherein the paper component is connected to the polymeric film.

Embodiment 4: A paper-based packaging film according to any previous embodiment, wherein the polymeric film does not extend into the fiber-network of the paper component.

Embodiment 5: The paper-based packaging film according to any previous embodiment, wherein the paper-based packaging film has a total composition including greater than or equal to 80% paper by weight, or greater than or equal to 85% paper by weight, or greater than or equal to 90% paper by weight, or greater than or equal to 95% paper by weight, and or wherein the paper-based has a recoverable content including greater than or equal to 80% by weight, or greater than or equal to 85% by weight, or greater than or equal to 90% by weight, based on the total weight of the paper-based packaging film.

Embodiment 6: The paper-based packaging film according to any previous embodiment, wherein the polymeric film is unoriented, monoaxially oriented or biaxially oriented.

Embodiment 7: The paper-based packaging film according to any previous embodiment wherein the polymeric film is oriented.

Embodiment 8: The paper-based packaging film according to any previous embodiment wherein the polymeric film has a thickness in a range of from 2 to 15 μm.

Embodiment 9: The paper-based packaging film according to any previous embodiment wherein the polymeric film comprises one or more materials selected from polypropylene (PP), polyester, polyethylene (PE), polyamide (PA) and polylactic acid (PLA).

Embodiment 10. The paper-based packaging film according to any previous embodiment wherein the polymeric film comprises one or more layers independently selected from monoaxially oriented polypropylene (OPP) film(s), biaxially oriented polypropylene (BOPP) film(s), monoaxially oriented polyethylene (OPE) film(s) biaxially oriented polyethylene (BOPE) film(s), monoaxially oriented polyester film(s), biaxially oriented polyester film(s), monoaxially oriented polyamide (OPA) film(s), biaxially oriented polyamide (BOPA) film(s), monoaxially oriented polylactic acid (OPLA) film(s), and biaxially oriented polylactic acid (BOPLA) film(s).

Embodiment 11: The paper-based packaging film according to any previous embodiment, wherein the sealable material is a heat sealable material or a pressure-sensitive cold seal material.

Embodiment 12: The paper-based packaging film according to any previous embodiment wherein the heat sealable material is a heat sealable lacquer or a hot melt adhesive.

Embodiment 13: The paper-based packaging film according to any previous embodiment, further comprising a barrier material.

Embodiment 14: The paper-based packaging film according to embodiment 13, wherein the barrier material is located between the paper component and the polymeric film.

Embodiment 15: The paper-based packaging film according to embodiments 13 or 14, wherein the barrier material is selected from a metal, an oxide or a combination thereof, deposited by vapor deposition.

Embodiment 16: The paper-based packaging film according to any of embodiments 13 to 15 wherein the barrier material provides a layer having a maximum thickness of less than 1 microns, preferably less than 0.5 microns.

Embodiment 17: The paper-based packaging film, according to any of embodiments 13 to 16 comprising a combination of polymeric film and barrier material selected from SiOx coated OPET, SiOx coated BOPP, AlOx coated OPET, AlOx coated BOPP, aluminum metal coated OPET and aluminum metal coated BOPP.

Embodiment 18: The paper-based packaging film according to any previous embodiment wherein each of the paper component, the polymeric film and the barrier material, if present, are fully coextensive with each other.

Embodiment 19: The paper-based packaging film according to any previous embodiment wherein the paper component comprises a paper layer and optionally one or more of a paper surface treatment, ink and/or over lacquer.

Embodiment 20: The paper-based packaging film according to any previous embodiment further comprising ink located on the first major outer surface and covers part or all of the first major surface.

Embodiment 21: The paper-based packaging film according to embodiment 20 wherein the ink comprises pigments.

Embodiment 22: The paper-based packaging film according to any previous embodiment, wherein the paper component has a basis weight in a range of from 30 g/m² to 360 g/m².

Embodiment 23: The paper-based packaging film according to any previous embodiment, wherein the paper component comprises calendered or supercalendered paper.

Embodiment 24: A paper-based packaging film according to any previous embodiment wherein the paper component comprises a paper layer having at least one surface treatment on one or both sides thereof with one or more agents (independently) selected from starches, alginates, carboxymethyl celluloses, polyvinyl alcohol, clay and combinations thereof.

Embodiment 25: The paper-based packaging film according to any previous embodiment wherein the paper component comprises paper selected from kraft paper, bleached paper, micro-fibrillated cellulose (MFC) paper, grease proof paper, machine glazed kraft paper (MGBK), one-side clay coated paper (C1S) and two-side clay-coated paper (C2S).

Embodiment 26. A paper-based packaging film according to any previous embodiment wherein the paper component has a top side and a reverse side opposite the top side, wherein the top side comprises said one or more second surface regions and wherein the one or more second surface regions independently comprise one or more of paper, a surface treatment, ink and over lacquer.

Embodiment 27. The paper-based packaging film according to any previous embodiment, further comprising an adhesive located between the paper component and the polymeric film or between the paper component and the barrier material if present.

Embodiment 28. The paper-based packaging film according to embodiment 30 wherein the adhesive attaches the paper component to the polymeric film or to the barrier material, if present.

Embodiment 29. The paper-based packaging film according to embodiment 27 or 28 wherein the adhesive comprises a material that is water-sensitive.

Embodiment 30. The paper-based packaging film according to embodiment 29 wherein the material is selected from latex/casein blends, starch, sugar derivatives, cellulose amino resin, polyacrylate, polyvinyl alcohol, polyvinyl acetate, polyacrylic acid, maleic acid-modified ethylene copolymers, methyl cellulose, carboxy-methylcellulose, carboxy-functional polyesters, polyethylene succinate, polybutylene succinate, ionomers hydrophilic polyurethane and combinations thereof.

Embodiment 31: A paper-based packaging film according to any previous embodiment, wherein the second major surface is a product-contact surface.

Embodiment 32: A paper-based packaging film as defined in any previous embodiment, wherein the paper component is located at an exterior surface of the paper-based packaging film; the polymeric film is located at an interior surface of the paper-based packaging film; and the patterned sealable material located at an exterior surface of the paper-based packaging film.

Embodiment 33: The paper-based packaging film as defined in any previous embodiment wherein the polymeric film is located at the interior surface.

Embodiment 34: A paper-based packaging film as defined in any previous embodiment, comprising a polymeric barrier film, wherein the polymeric barrier film is an oriented or unoriented film having a metal or oxide coating and wherein optionally the barrier coated side of the polymeric film is attached to the paper component by an adhesive.

Embodiment 35: A paper-based packaging film according to any previous embodiment, comprising
a barrier material located between the paper component and the polymeric film, and
an adhesive located between the barrier material and the paper component.

Embodiment 36: The paper-based packaging according to embodiment 35 wherein:
the heat sealable comprises a water-based dispersion based on EVA-copolymer resin; and/or
the paper component comprises a supercalendered, reverse side untreated, top side uncoated, machine finished paper layer; and/or
the polymeric film is oriented polypropylene; and/or
the barrier material comprises metal vapor deposited onto the polymeric film; and/or
the adhesive is a water-based adhesive, formulated using synthetic or natural based polymers.

Embodiment 37: A package formed from or including a paper-based packaging film as defined in any of embodiments 1 to 36.

Embodiment 38: A fold package formed from a paper-based packaging film as defined in any of embodiments 1 to 37.

Embodiment 39: The package according to embodiment 37 or embodiment 38 further comprising a packaged product.

Embodiment 40: A packaged cuboid product comprising:
a paper-based packaging film as defined in any of embodiments 1 to 36, and
a product having a cuboid shape;
   wherein the paper-based packaging film is wrapped around the product such that the first major surface of the packaging film is facing away from the product.

Embodiment 41: The packaged cuboid product according to embodiment 40 wherein the second major surface of the paper-based packaging film comprises the polymeric film and is facing the product.

Embodiment 42: The packaged cuboid product according to embodiment 40 or 41 wherein the second major surface is in contact with each side of the product.

Embodiment 43: The packaged cuboid product according to any of embodiments 40 to 42 comprising an individually wrapped product having a cuboid shape.

Embodiment 44: The packaged cuboid product according to any of embodiments 40 to 42 wherein the product comprises a cuboid block product consisting of multiple separable cuboid compartments and the paper-based packaging film is wrapped around the cuboid block product.

Embodiment 45: The packaged cuboid product according to any of embodiments 40 to 45 wherein the packaged product is sealed by the patterned sealable material.

Embodiment 46: The packaged cuboid product according to any of embodiments 40 to 45 wherein the product is a food product comprising one or more components selected from grease, salt, sugar, food concentrates, dried food components and spices.

Embodiment 47: The packaged cuboid product according to any of embodiments 40 to 46 wherein the product is a bouillon cube.

Embodiment 48: A paper-based packaging film (which may be a flexible paper-based packaging film in typical embodiments) comprising a polymeric film, optionally a barrier material, a paper component and a patterned sealable material. The total composition of the paper-based packaging film may be greater than or equal to 80%, greater than or equal to 85%, greater than or equal to 90% or greater than or equal to 95% by weight of the paper component; and a package comprising the paper-based packaging film, and optionally a product.

Embodiment 49: A paper-based packaging film or product as described in Embodiment 48, wherein the interior surface comprises the polymeric film and the exterior surface comprises each of the paper component and the sealable material.

Embodiment 50: A paper-based packaging film according to Embodiment 48 or 49, wherein the film is characterized as described for any one or more of embodiments 1 to 36; and/or the product is characterized as described for any one or more of embodiments 37 to 47.

### EXAMPLES

### Measurements

In some embodiments, the paper-based packaging film may be used in a repulping process. The repulping process, as described further below, removes the paper content from the paper-based packaging film and measures the non-paper content of the paper-based packaging film.

The recyclability may be assessed by recoverable content, this is all the material that can be recovered to produce new paper. The following procedure was used to determine the recoverable paper content after a repulping process.

In some embodiments, a test method for separating, for the purpose of recycling materials, the paper content from non-paper content is used. This test consists of soaking the starting material (i.e., the paper-based packaging film) in a beaker containing hot water and mixing it to separate the paper from the polymeric film and measure the quantity of recovered paper pulp. In general, the equipment used includes:
5×5 cm cutting template
Graduated beaker that can hold 500 ml of water
Heating plate pre-set at 45° C.
Propeller stirrer with adjustable rotation speed
Thermometer to control the water temperature
Precision scale
Oven set at 70° C.

In general, the process used to measure an amount of recoverable paper content includes:
1. Turn on the hot plate.
2. From the sample of about 1 m, cut ten samples of 5*5 cm.
3. Weigh the ten samples (P1).
4. Fill the beaker with 500 ml of water at 45° C.+/−2° C.
5. Place the filled beaker on the pre-set hotplate.
6. Regularly measure the temperature of the water using the thermometer.
7. Introduce the rotary support with the propeller closest to the bottom of the beaker.
8. Place the samples in the water in the beaker.
9. Start the rotation of the agitator by adjusting it so as to have a rotation speed of 1100 rpm.
10. Leave to run for 15 minutes, regularly checking the water temperature.
11. At the end of the measurement, switch off the heating plate and remove the stirrer.
12. Remove the beaker and remove the ten pieces of polymeric film and put them on a paper towel to drain them and put them in the oven set at 70° C. between two paper towels to dry them for 24 hours.
13. Let the ten pieces of polymeric film recondition at room temperature for at least 24 hours and weigh the ten films (P2).
14. Determine the recoverable content as P2 divided by P1×100 wt.-%.

### EXAMPLE

The disclosure is now described with reference to the following Inventive Example.

Inventive Example 1 is an example based on the paper-based packaging films having one or more components/layers/films as described above. The general structures of the paper-based packaging film of inventive Example 1 are described below.

### Structure:

Patterned sealable: Heat Seal Lacquer (“HSL”, registered): EVA based (2 gsm)
Overlacquer (“OVL”, registered): nitrocellulose based
Ink: nitrocellulose based
Paper: MGBK paper (50 gsm)
Water-sensitive adhesive: (1.5 gsm)
Polymeric Film 8 μm metOPP (7.3 gsm)

Inventive Example 1 was produced by a method which used water-based lamination and gravure printing to apply inks, HSL and OVL. More specifically, the inventive Example 1 was produced by laminating the paper component to the metallized side of the metOPP by using a water-sensitive adhesive. On the first major outer surface (i.e., of the paper) the ink was applied by gravure printing and subsequently overlacquer and heat seal lacquer were applied in registration. The heat seal material was applied in a pattern similar to the one shown in FIG. 6.

The film of Example 1 has a calculated paper content of greater than about 80% by weight, based on the total composition of the paper-based-packaging film. The packaging film of example 1 could be repulped using a standard laboratory disintegrater. When tested according to Aticelca 501 (2019) method, the packaging film of inventive Example 1 could be certified as Level “B”. In this test, 13.6% of the weight was lost to coarse rejects and 2.1% of the weight to “Fibre flakes”, retaining a content of 84.3% by weight of the paper-based packaging film. It is believed that using a higher paper content (for example 100 gsm paper instead of 50 gsm paper in the above exemplified structure) can further increase the recovered content, thus achieving a rating of Level A according to the Aticelca 501 (2019) standard. The paper-based packaging films described and exemplified herein are suitable for recycling in a standard paper recycling process and for packaging cuboid products, like bouillon cubes.

The paper-based packaging films described and exemplified herein show high barrier properties (in particular, against moisture and grease), folding properties, and excellent sealing performance, while maintaining recyclability in a standard paper recycling process. The packaging films maintain excellent appearance during packaging converting and package use and storage and do not show stains from grease when packaging bouillon cubes. The packaging films described and exemplified herein can be run on high-speed packaging machines.

Although the disclosure herein has been described with reference to particular embodiments and Inventive Example, it is to be understood that these embodiments and Inventive Example are merely illustrative of the principles and applications of the present disclosure.

1. A paper-based packaging film having a first major outer surface and a second major outer surface, the paper-based packaging film comprising:
a paper component;
a polymeric film; and
a patterned sealable material;
wherein the first major outer surface comprises one or more first surface regions provided by the patterned sealable material and one or more second surface regions provided by the paper component;
the second major outer surface is a product contact surface and is provided by the polymeric film.

2. (canceled)

3. A paper-based packaging film according to claim 1, wherein the paper component is connected to the polymeric film.

4. A paper-based packaging film according to claim 1, wherein the polymeric film does not extend into the fiber-network of the paper component.

5. The paper-based packaging film according to claim 1, wherein the paper-based packaging film has a paper content including greater than or equal to 80% paper by weight, based on the total weight of the paper based packaging film.

6. The paper-based packaging film according to claim 1, wherein the paper-based packaging film has a recoverable content including greater than or equal to 80% by weight, based on the total weight of the paper based packaging film.

7. (canceled)

8. The paper-based packaging film according to claim 1, wherein the polymeric film is oriented.

9. The paper-based packaging film according to claim 1, wherein the polymeric film has a thickness in a range of from 2 to 15 μm.

10. The paper-based packaging film according to claim 1, wherein the polymeric film comprises one or more materials selected from polypropylene (PP), polyester, polyethylene (PE), polyamide (PA) and polylactic acid (PLA).

11. (canceled)

12. The paper-based packaging film according to claim 1, wherein the sealable material is a heat sealable material or a pressure-sensitive cold seal material.

13. The paper-based packaging film according to claim 1, wherein the heat sealable material is a heat sealable lacquer or a hot melt adhesive.

14. The paper-based packaging film according to claim 1, further comprising a barrier material.

15. The paper-based packaging film according to claim 14, wherein the barrier material is located between the paper component and the polymeric film.

16. The paper-based packaging film according to claim 14, wherein the barrier material is selected from a metal, an oxide or a combination thereof, deposited by vapor deposition.

17. (canceled)

18. The paper-based packaging film, according to claim 14 comprising a combination of polymeric film and barrier material selected from SiOx coated OPET, SiOx coated BOPP, AlOx coated OPET, AlOx coated BOPP, aluminum metal coated OPET and aluminum metal coated BOPP.

19. (canceled)

20. The paper-based packaging film according to claim 1, wherein the paper component comprises a paper layer and optionally one or more of a paper surface treatment, ink and/or over lacquer.

21.-22. (canceled)

23. The paper-based packaging film according to claim 1, wherein the paper component has a basis weight in a range of from 30 g/m² to 360 g/m².

24. The paper-based packaging film according to claim 1, wherein the paper component comprises calendered or supercalendered paper.

25.-27. (canceled)

28. The paper-based packaging film according to claim 1, further comprising an adhesive located between the paper component and the polymeric film.

29.-37. (canceled)

38. A package formed from or including a paper-based packaging film as defined in claim 1.

39.-40. (canceled)

41. A packaged cuboid product comprising:
a paper-based packaging film as defined in claim 1, and
a product having a cuboid shape;
wherein the paper-based packaging film is wrapped around the product such that the first major surface of the packaging film is facing away from the product.

42.-48. (canceled)
